(19) United States
(12) Patent Application Publication
(10) Pub. No.: US 2024/0330375 A1
(43) Pub. Date: Oct. 3, 2024

(54) COMPARISON OF NAMES

(71) Applicant: DocuSign, Inc, San Francisco, CA (US)

(72) Inventors: Iuliia Iakimova, Issy-les-Moulineaux (FR); Mustafa Mert Gokce, Paris (FR); Cyril Thirion, Chaville (FR)

(21) Appl. No.: 18/194,345

(22) Filed: Mar. 31, 2023

(51) Int. Cl. G06F 16/93; G06F 18/2415

(52) U.S. Cl. CPC G06F 16/93; G06F 18/2415

(57) ABSTRACT

Techniques are described for recognizing alternative representations of the same name. An example method includes transmitting, by a document management platform implemented by a computing system, a document package to a second computing device. The document package includes a document received from a first computing device and an indication of first name. The document management platform obtains an indication of a second name from an identity document provided by a user of the second computing device. The document management platform performs a name matching operation using a machine learning model to determine whether the first name and the second name are similar based on a similarity score generated by the machine learning model. Based on determining that the first name and the second name are similar, the document management platform grants the user of the second computing device access to the document.

### TECHNICAL FIELD

This disclosure relates generally to electronic document management, and more specifically to a comparison of names.

### BACKGROUND

Document management systems manage electronic documents for various entities (e.g., people, companies, organizations). Such electronic documents may include various types of agreements that can be executed (e.g., electronically signed) by entities, such as non-disclosure agreements, indemnity agreements, purchase orders, lease agreements, employment contracts, and the like. Document management systems may employ techniques to verify an identity of an entity before allowing the entity to interact with a document, such as to execute an agreement.

### SUMMARY

Aspects of the present disclosure describe techniques for recognizing alternative representations of the same name. Document management platforms may offer identity verification function. For example, the document management platform may receive, from a sender, a request to provide a document to a user identified using an e-mail address and a first name (e.g., one or more of a given name, a middle name, and a family name) to access and/or sign the document. In this example, the document management platform may obtain, with an identity verification manager, a second name (e.g., one or more of a given name, a middle name, and a family name) for the user using an identity document (e.g., a government issued identification). The document management platform may compare the first name (e.g., a name string) identifying the recipient provided by the sender and the second name (e.g., a name string) obtained from the identity document. In case the first name and the second name do not exactly match, the document management platform may apply hybrid techniques to determine whether the first name and second name identify the same person.

The hybrid techniques described herein may first use machine learning technology to achieve a maximum variation level, and/or may utilize a rule-based approach to achieve the maximum variation level. In contrast, techniques that achieve a minimum variation may allow minor variations for the first and last names only. For example, techniques that achieve the minimum variation may ignore case sensitivity, ignore special characters (e.g., dots and commas), allow transliterations (e.g., Sean O'Hara compared to Sean ÓHara), require one first name, require one last name, ignore diacritics (e.g., Chloe Nikolic compared to Chloé Nikolić), and/or perform initial matching. Techniques that achieve a moderation may allow additional variation of middle names and suffixes. For example, techniques that achieve the minimum variation may further allow middle name initial matching (e.g., Mary A. Williams matches Mary Alexandra Williams) and suffix variation matching. Examples of suffix variation matching may include: Senior matches “Snr” and “Sr.” and Junior matches “Jnr”, “Jr” and, “Jr.”

In accordance with the techniques of the disclosure, a document management platform may be configured to use a machine learning approach to recognize what two similar names look like by leveraging various learning elements such as a database of matched name pairs (e.g., a training dataset), phonetic indexing (e.g., indexing that encodes names based on their English pronunciation), similarity distance metrics (e.g., metrics that assess a difference between the two name strings character by character) and a number of common letters between the two name strings. The rule-based approach may take the second step in the hybrid techniques and may match the names that were rejected by the machine-learning approach due to dissimilarity. The rule-based approach may apply diacritical conversion, transliterations, and may eliminate middle names from the corresponding name strings to enhance the matching process. The techniques described herein may provide one or more technical advantages that realize a practical application. For example, the hybrid techniques may increase the success rates for name matching compared to techniques relying on only exact matches or only exact matching with the rule-based approach. In addition, the hybrid techniques may reduce the number of false negatives.

In one example, the present disclosure describes a method that includes transmitting, by a document management platform implemented by a computing system, a document package to a second computing device. The document package includes a document received from a first computing device and an indication of first name. The document management platform obtains an indication of a second name from an identity document provided by a user of the second computing device. The document management platform performs a name matching operation using a machine learning model to determine whether the first name and the second name are similar based on a similarity score generated by the machine learning model. Based on determining that the first name and the second name are similar, the document management platform grants the user of the second computing device access to the document.

In another example, the present disclosure describes a computing system comprising a storage device and processing having access to the storage device. The processing circuitry is configured to transmit a document package to a second computing device, wherein the document package includes a document received from a first computing device and an indication of first name and obtain an indication of a second name from an identity document provided by a user of the second computing device. The processing circuitry is further configured to perform a name matching operation using a machine learning model to determine whether the first name and the second name are similar based on a similarity score generated by the machine learning model; and, based on determining that the first name and the second name are similar, grant the user of the second computing device access to the document.

In one example, the present disclosure describes a computer-readable storage medium comprising instructions that, when executed, configure processing circuitry of a computing system to transmit a document package to a second computing device, wherein the document package includes a document received from a first computing device and an indication of first name and obtain an indication of a second name from an identity document provided by a user of the second computing device. The instructions further cause the processing circuitry to perform a name matching operation using a machine learning model to determine whether the first name and the second name are similar based on a similarity score generated by the machine learning model and, based on determining that the first name and the second name are similar, grant the user of the second computing device access to the document.

The details of one or more examples of the techniques of this disclosure are set forth in the accompanying drawings and the description below. Other features, objects, and advantages of the techniques will be apparent from the description and drawings, and from the claims.

### BRIEF DESCRIPTION OF THE DRAWINGS

FIGS. 1A-1B are block diagrams illustrating example systems that perform comparison of names, in accordance with one or more aspects of the present disclosure.

FIG. 2 is a block diagram illustrating example system, in accordance with techniques of this disclosure.

FIG. 3 is a block diagram illustrating training of a machine learning model, in accordance with techniques of this disclosure.

FIG. 4 is a block diagram illustrating prediction performed by a machine learning model, in accordance with techniques of this disclosure.

FIG. 5 is a flow chart illustrating an example mode of operation for a documentation platform to perform comparison of names, in accordance with techniques of this disclosure.

FIG. 6 is a block diagram illustrating an example instance of a name matching manager that performs comparison of names, in accordance with one or more aspects of the present disclosure.

Like reference characters denote like elements throughout the text and figures.

### DETAILED DESCRIPTION

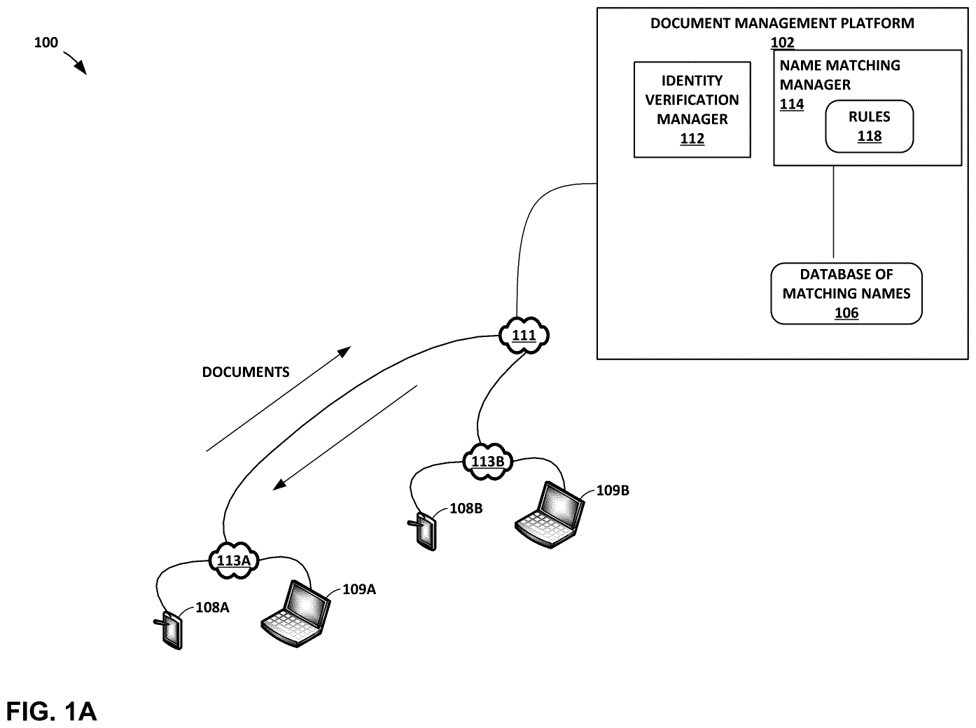

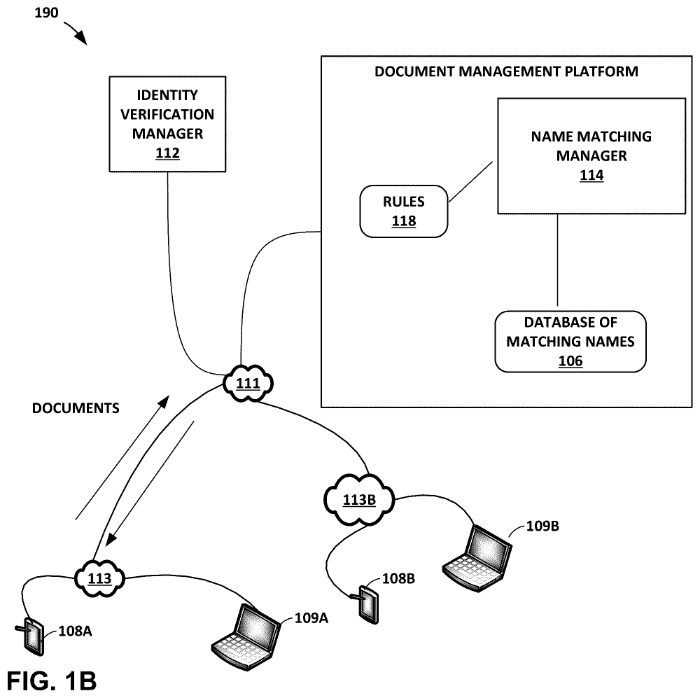

FIGS. 1A-1B are block diagrams illustrating example systems that perform comparison of names, in accordance with one or more aspects of the present disclosure. In the example of FIG. 1A, system 100 includes a centralized document management platform 102 that provides storage and management of documents or document packages for various users. Document management platform 102 may include a collection of hardware devices, software components, and/or data stores that can be used to implement one or more applications or services provided to one or more mobile devices 108 and one or more client devices 109 via a network 113. The document management platform 102 may be configured to allow a sender to create and send documents to one or more recipients for negotiation, collaborative editing, electronic execution (e.g., electronic signature), automation of contract fulfilment, archival, and analysis, among other tasks. In one non-limiting example, a user of mobile device 108B and/or client device 109B may be a sender of a document package (e.g., envelope) and a user of mobile device 108A and/or client device 109A may be a recipient of the document package. Within the system environment, a recipient may review content or terms presented in a digital document, and in response to agreeing to the content or terms, can electronically execute the document. In some aspects, in advance of the execution of the documents, the sender may generate a document package to provide to the one or more recipients. The document package may include at least one document to be executed by one or more recipients. In some examples, the document package may also include one or more permissions defining actions the one or more recipients can perform in association with the document package. In some examples, the document package may also identify tasks the one or more recipients are to perform in association with the document package.

The document management platform 102 described herein may be implemented within a centralized document system, an online document system, a document management system, or any type of digital management platform. Although description may be limited in certain contexts to a particular environment, this is for the purposes of simplicity only, and in practice the principles described herein may apply more broadly to the context of any digital management platform. Examples may include but are not limited to online signature systems, online document creation and management systems, collaborative document and workspace systems, online workflow management systems, multi-party communication and interaction platforms, social networking systems, marketplace and financial transaction management systems, or any suitable digital transaction management platform.

The document management platform 102 may be located on premises and/or in one or more data centers, with each data center a part of a public, private, or hybrid cloud. The applications or services may be distributed applications. The applications or services may support enterprise software, financial software, office or other productivity software, data analysis software, customer relationship management, web services, educational software, database software, multimedia software, information technology, health care software, or other type of applications or services. The applications or services may be provided as a service (-aaS) for Software-aaS, Platform-aaS, Infrastructure-aaS, Data Storage-aas (dSaaS), or other type of service.

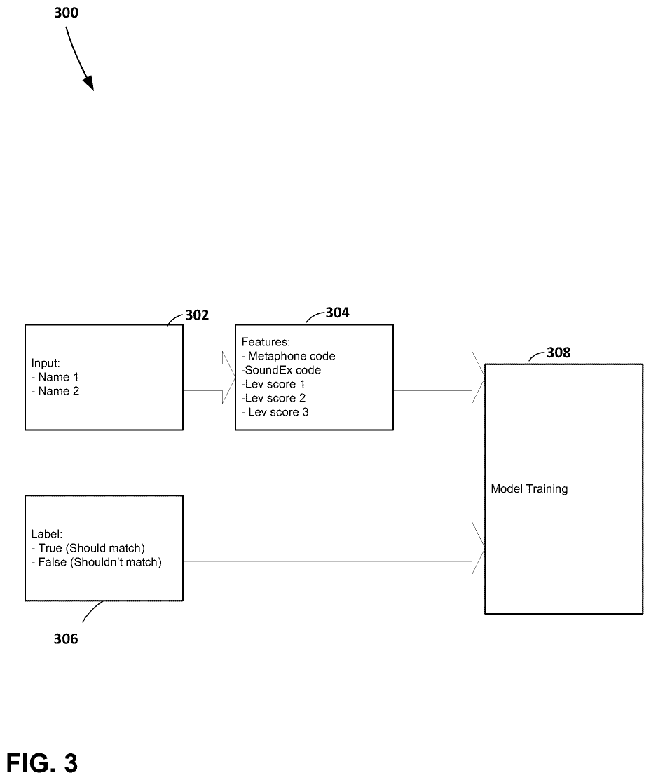

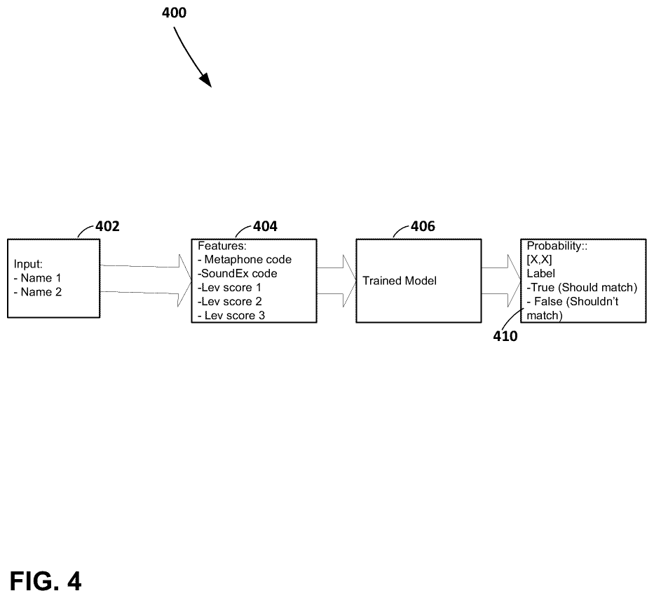

In some examples, document management platform 102 may verify the identity of one or more recipients to perform one or more actions in relation to a document package, such as executing an agreement, accessing a document, modifying a document, or any other suitable action. In particular, the document management platform 102 may facilitate a maximum variation name matching approach wherein an approximate name matching is performed that identifies similar but not necessarily identical names. In an example, the maximum variation name matching approach may use a hybrid method of machine learning technology and rule-based algorithms name matching process. As an example, recipient name data may be included in a document package. The name matching process may include one or more name matching operations whereby features of the name data provided by a sender and name data provided by a recipient are compared. A name matching operation may be first performed by a machine learning model trained to recognize what two similar names look like by leveraging various learning elements described below. If the machine learning model does not detect a match between provided name data, an additional name matching operation may be performed by applying one or more name matching rules of a set of name matching rules to relevant name features. In an aspect, the name matching rules may describe constraints for determining whether a name feature of the name provided by a recipient is an allowed alternative representation of a name provided by a sender, or vice versa. Particular examples of machine learning models and name matching rules are described in detail below with reference to FIGS. 3 and 4.

In the example of FIG. 1A, the document management platform 102 may enable mobile devices 108A-108B (collectively, mobile devices 108 or simply devices 108) and client devices 109A-109B (collectively, client devices 109 or simply devices 109) to access documents, via network 111 using a communication protocol, as if such document was stored locally (e.g., to a hard disk of a corresponding device 108, 109). Example communication protocols for accessing documents and objects may include, but are not limited to, Server Message Block (SMB), Network File System (NFS), or AMAZON Simple Storage Service (S3).

The document management platform 102 may include a database of matching names 106 that may be stored on one or more storage devices. The storage devices may represent one or more physical or virtual computer and/or storage devices that include or otherwise have access to storage media. Such storage media may include one or more of Flash drives, solid state drives (SSDs), hard disk drives (HDDs), forms of electrically programmable memories (EPROM) or electrically erasable and programmable (EEPROM) memories, and/or other types of storage media used to support the document management platform 102. In some examples, document management platform 102 may communicate with user devices (e.g., the sender device 108B, 109B or the recipient device 108A, 109A) over the network 113 to receive instructions and send document packages (or other information) for viewing on user devices.

Each of networks 113A and 113B and network 111 may include the Internet or may include or represent any public or private communications network or other network. For instance, networks 113 may be a cellular, Wi-Fi®, ZigBee®, Bluetooth®, Near-Field Communication (NFC), satellite, enterprise, service provider, and/or other type of network enabling transfer of data between computing systems, servers, computing devices, and/or storage devices. One or more of such devices may transmit and receive data, commands, control signals, and/or other information across network 113 or network 111 using any suitable communication techniques. Each of network 113 or network 111 may include one or more network hubs, network switches, network routers, satellite dishes, or any other network equipment. Such network devices or components may be operatively inter-coupled, thereby providing for the exchange of information between computers, devices, or other components (e.g., between one or more client devices or systems and one or more computer/server/storage devices or systems). Each of the devices or systems illustrated in FIGS. 1A-1B may be operatively coupled to network 113 and/or network 111 using one or more network links. The links coupling such devices or systems to network 113 and/or network 111 may be Ethernet, Asynchronous Transfer Mode (ATM) or other types of network connections, and such connections may be wireless and/or wired connections. One or more of the devices or systems illustrated in FIGS. 1A-1B or otherwise on network 113 and/or network 111 may be in a remote location relative to one or more other illustrated devices or systems.

Data exchanged over the network 113 and/or network 111 may be represented using any suitable format, such as hypertext markup language (HTML), extensible markup language (XML), or JavaScript Object Notation (JSON). In some aspects, the network 113 and/or network 111 may include encryption capabilities to ensure the security of documents. For example, encryption technologies may include secure sockets layers (SSL), transport layer security (TLS), virtual private networks (VPNs), and Internet Protocol security (IPsec), among others.

In an example, a user of a computing device (e.g., the sender device 108B, 109B or the recipient device 108A, 109A) may represent an individual user, group, organization, or company that is able to interact with document packages (or other content) generated on or managed by the document management platform 102. Each user may be associated with a username, email address, full or partial legal name, or other identifier that may be used by the document management platform 102 to identify the user and to control the ability of the user to view, modify, execute, or otherwise interact with document packages managed by the document management platform 102. In some aspects, users may interact with the document management platform 102 through a user account with the document management platform 102 and one or more user devices accessible to that user.

In an example, a user of the sender device 108B, 109B may create the document package via the document management platform 102. The document package may be sent by the document management platform 102 for review and execution by the user of the recipient device 108A, 109A. As described in greater detail below, the user of the recipient device 108A, 109A may be associated with an email address provided by the user of the sender device 108B, 109B.

In the example of FIG. 1A, the document management platform 102 may include an identity verification manager 112 that may provide verification of an identity of the user of the recipient device 108A, 109A to execute a received document and a name matching manager 114 that may perform comparison of names. For example, identity verification manager 112 may obtain a second name from an identity document. Examples of an identity document may include, but are not limited to, for example, a driver's license, a passport, or other form of government issued identification. For example, the identity verification manager 112 may obtain an image of the identity document to provide to the document management platform 102, such as by using a camera component of the recipient device 108A, 109A to capture the image. In various aspects, the identity verification manager 112 may process the image of the identity document to extract identity (e.g. a second name) of the user.

As shown in FIG. 1B, in some aspects, the identity verification manager 112 may be implemented/hosted by a trusted third-party service provider storing identity information for the user of the recipient device 108A, 109A, such as a private or governmental database storing identity information corresponding to one or more individuals. In this case, the recipient device 108A, 109A may obtain identity data (e.g., name) from the trusted service provider (e.g., identity verification manager 112) for providing to the document management platform 102. Alternatively, the recipient device 108A, 109A may authorize the trusted service provider (e.g., identity verification manager 112) to provide identity data directly to the document management platform 102.

The name matching manager 114 may perform a name matching operation using a machine learning model to determine whether the names provided by a sender and a recipient are similar based on a similarity score generated by the machine learning model. Name matching manager 114 may determine the similarity score based on, for example, one or more of a phonetic similarity, a character similarity, or a character of name equivalence that is trained on a database of equivalent and/or non-equivalent names. In response to the machine learning model determining that provided names are not similar, the name matching manager 114 may apply one or more name matching rules 118 describing constraints for determining whether, for example, the name of a recipient user is an allowed alternative representation of the name provided by a sender user. If the corresponding names match or found to be similar, the document management platform 102 may grant user of the recipient device access to the document.

For example, if the similarity score is above a fixed threshold (e.g., a predetermined threshold or a configurable threshold), name matching manager 114 may determine that the provided names are similar. With the threshold, name matching manager 114 may determine two names to be similar if 1) the name is found to be equivalent, or 2) there is only one character difference, or 3) names are phonetically almost identical and have a 2 or less character difference. Name matching manager 114 may determine that any name that does not meet one of these criteria will not be considered a match. As used herein, phonetic similarity may refer to how similar do the two names sound. Character similarity may refer to a difference in characters between the two names. A character of equivalence may be based on a data set of equivalent and non-equivalent names. In this way, name matching manager 114 may perform a name matching operation using a machine learning model to determine that the names “Hayley Atwell” and “Hailey Atwell” match (e.g., phonetically identical), that “Conrad Jenkins” and “Konrad Jenkins” match (one character difference), and that “Patrick McKnight” and “Patricia McKnight” do not match (not phonetically identical).

Although the name matching functionality is described herein in the context of granting/denying access to the document, the present disclosure is not limited to this context and is applicable in other situations where the document management platform 102 performs actions based on a successful name matching operation. Name matching may be only one of a plurality of operations/checks that may be required to grant user of the recipient device access to the document. For example, document management platform 102 may grant access to the document in response to validating that the identity of the recipient belongs to the person expected by the sender and further in response to one or more other conditions being satisfied.

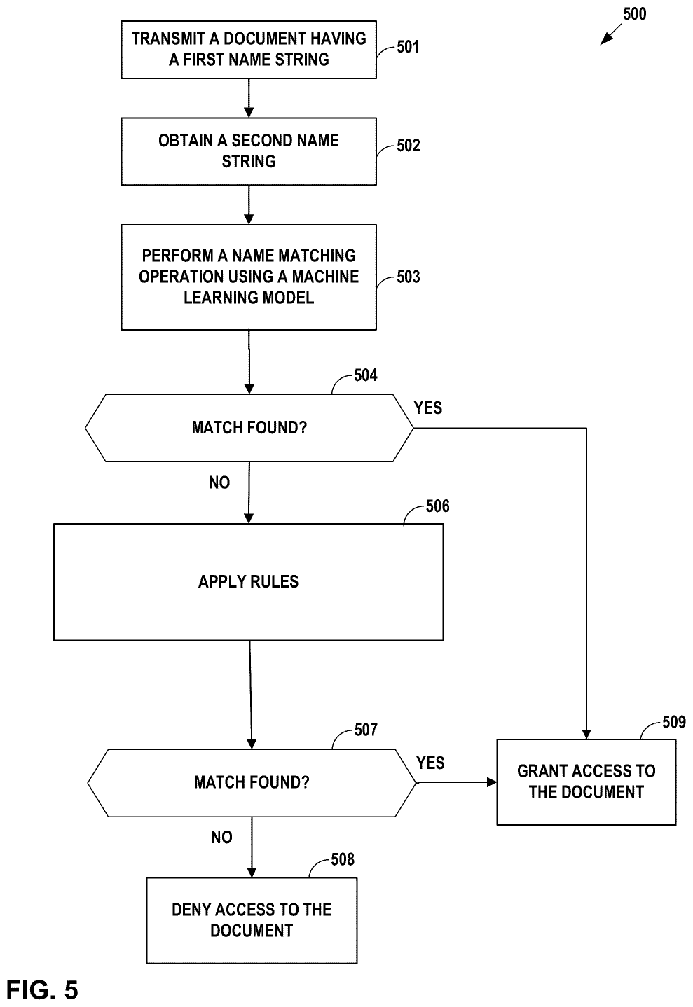

As described above, the name matching rules 118 may describe constraints for determining whether a name feature of the name provided by a recipient is an allowed alternative representation of a name provided by a sender, or vice versa. The name matching rules may include rules relating to different types of name features, such as letter cases, diacritics, transliterations, name types (e.g., first, middle, last), special characters (e.g., initials), suffixes, etc. Applying name matching rules relating to various types of name features are described in greater detail below with reference to FIG. 5. In some examples, the name matching rules 118 can be stored outside of the name matching manager 114, as shown in FIG. 1B.

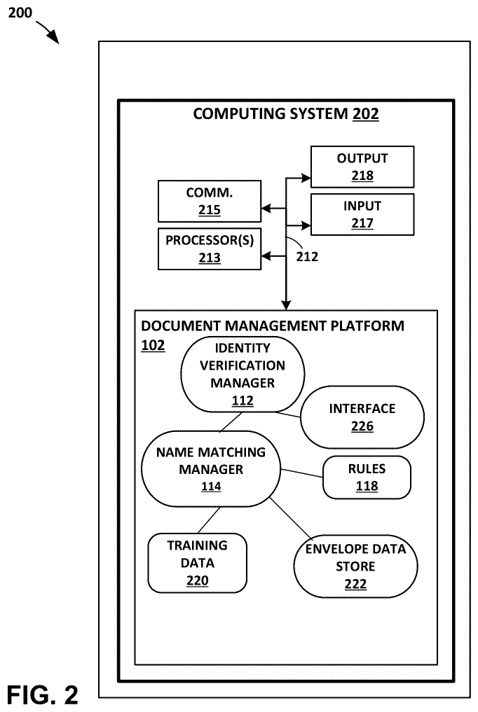

FIG. 2 is a block diagram illustrating example system 200, in accordance with techniques of this disclosure. System 200 of FIG. 2 may be described as an example or alternate implementation of system 100 of FIG. 1A or system 190 of FIG. 1B. One or more aspects of FIG. 2 may be described herein within the context of FIG. 1A and FIG. 1B.

In the example of FIG. 2, system 200 includes the document management platform 102 implemented by computing system 202. In FIG. 2, the document management platform 102 may correspond to the document management platform 102 of FIGS. 1A and 1B.

Computing system 202 may be implemented as any suitable computing system, such as one or more server computers, workstations, mainframes, appliances, cloud computing systems, and/or other computing systems that may be capable of performing operations and/or functions described in accordance with one or more aspects of the present disclosure. In some examples, computing system 202 represents a cloud computing system, server farm, and/or server cluster (or portion thereof) that provides services to other devices or systems. Computing system 202 may represent or be implemented through one or more virtualized computer instances (e.g., virtual machines, containers) of a cloud computing system, server farm, data center, and/or server cluster.

In the example of FIG. 2, computing system 202 may include one or more communication units 215, one or more input devices 217, one or more output devices 218, and the document management platform 102. The document management platform 105 may include interface module 226, identity verification manager 112, name matching manager 114, one or more name matching rules 118, training data 220, and envelope store data 222. One or more of the devices, modules, storage areas, or other components of computing system 202 may be interconnected to enable inter-component communications (e.g., physically, communicatively, and/or operatively). In some examples, such connectivity may be provided by through communication channels (e.g., communication channels 212), which may represent one or more of a system bus, a network connection, an inter-process communication data structure, or any other method for communicating data.

One or more processors 213 of computing system 202 may implement functionality and/or execute instructions associated with computing system 202 or associated with one or more modules illustrated herein and/or described below. One or more processors 213 may be, may be part of, and/or may include processing circuitry that performs operations in accordance with one or more aspects of the present disclosure. Examples of processors 213 include microprocessors, application processors, display controllers, auxiliary processors, one or more sensor hubs, and any other hardware configured to function as a processor, a processing unit, or a processing device. Computing system 202 may use one or more processors 213 to perform operations in accordance with one or more aspects of the present disclosure using software, hardware, firmware, or a mixture of hardware, software, and firmware residing in and/or executing at computing system 202.

One or more communication units 215 of computing system 202 may communicate with devices external to computing system 202 by transmitting and/or receiving data, and may operate, in some respects, as both an input device and an output device. In some examples, communication units 215 may communicate with other devices over a network. In other examples, communication units 215 may send and/or receive radio signals on a radio network such as a cellular radio network. In other examples, communication units 215 of computing system 202 may transmit and/or receive satellite signals on a satellite network. Examples of communication units 215 include, but are not limited to, a network interface card (e.g., such as an Ethernet card), an optical transceiver, a radio frequency transceiver, a GPS receiver, or any other type of device that can send and/or receive information. Other examples of communication units 215 may include devices capable of communicating over Bluetooth®, GPS, NFC, ZigBee®, and cellular networks (e.g., 3G, 4G, 5G), and Wi-Fi® radios found in mobile devices as well as Universal Serial Bus (USB) controllers and the like. Such communications may adhere to, implement, or abide by appropriate protocols, including Transmission Control Protocol/Internet Protocol (TCP/IP), Ethernet, Bluetooth®, NFC, or other technologies or protocols.

One or more input devices 217 may represent any input devices of computing system 202 not otherwise separately described herein. Input devices 217 may generate, receive, and/or process input. For example, one or more input devices 217 may generate or receive input from a network, a user input device, or any other type of device for detecting input from a human or machine.

One or more output devices 218 may represent any output devices of computing system 202 not otherwise separately described herein. Output devices 218 may generate, present, and/or process output. For example, one or more output devices 218 may generate, present, and/or process output in any form. Output devices 218 may include one or more USB interfaces, video and/or audio output interfaces, or any other type of device capable of generating tactile, audio, visual, video, electrical, or other output. Some devices may serve as both input and output devices. For example, a communication device may both send and receive data to and from other systems or devices over a network.

One or more processors 213 may provide an operating environment or platform for various modules described herein, which may be implemented as software, but may in some examples include any combination of hardware, firmware, and software. One or more processors 213 may execute instructions of one or more modules. The processors 213 may retrieve, store, and/or execute the instructions and/or data of one or more applications, modules, or software. Processors 213 may also be operably coupled to one or more other software and/or hardware components, including, but not limited to, one or more of the components of computing system 202 and/or one or more devices or systems illustrated as being connected to computing system 202.

The document management platform 102 may perform functions relating to storage and management of documents or document packages (e.g., envelopes) for various users, as described above with respect to FIGS. 1A and 1B. The identity verification manager 112 may provide verification of an identity of the user of the recipient device 108A, 109A.

The identity verification manager 112 may interact with and/or operate in conjunction with one or more modules of computing system 202, including the interface module 226 and the name matching manager 114.

The name matching manager 114 may perform a name matching operation using a machine learning model to determine whether the names provided by a sender and a recipient are similar based on a similarity score generated by the machine learning model, as described above with respect to FIG. 1A. In response to the machine learning model determining that provided names are not similar, the name matching manager 114 may apply one or more name matching rules 118 describing constraints for determining whether, for example, the name of a recipient user is an allowed alternative representation of the name provided by a sender user. The name matching rules 118 may include rules relating to different types of name features, such as letter cases, diacritics, transliterations, name types (e.g., first, middle, last), special characters (e.g., initials), suffixes, etc.

As noted above, the name matching manager 114 may utilize training data 220 for learning how to identify patterns and make a name matching prediction. In an aspect, the training data 220 may include a large data set of labeled data. For example, the training data 220 may have pairs of names and a label (such as True (Match)/False (Not match). Some names may be ambiguous, in that they can refer to different instances of the same class of things (names). In the context of the training data 220, an ambiguous name can refer to two or more different names. In one example, the enumeration of the different senses of a name may be held in a disambiguation page. Alternatively, this may be expressed as saying a disambiguation page lists all named entity articles that may be denoted by a particular ambiguous entity name. For each different sense of an ambiguous name, there is an associated description of the name with the sense. For example, for the named entity “A. W. Black”, a disambiguation page can list a number of different entities which have the same name (for example, Alexander William Black, Arthur Black, and the like). In this example, name matching manager 114 may determine that “A. W. Black” and “Alexander William Black” match. Name matching manager 114 may generate training data 220 to include, for example, a database entry including:
Name 1: A. W. Black
Name 2: Alexander William Black
Match?: True

In the foregoing example, name matching manager 114 may determine a name pair that matches (e.g., “Match?=True”). However, in other examples, matching manager 114 determines a name pair that does not matches (e.g., “Match?=False)” using one or more a disambiguation pages.

The envelope data store 222 may be a file storage system, database, set of databases, or other data storage system storing information associated with document envelopes. A user of the mobile device 108B may provide a document package to a user of the client device 109A (a recipient of the document package) via envelopes. A document envelope (also referred to as a document package herein) may include at least one document for execution. The at least one document may have been previously negotiated by a sender and a recipient. And, as such, the document may be ready for execution upon the creation of an envelope. The document package may also include recipient information and document fields indicating which fields of the document need to be completed for execution (e.g., where the recipient should sign, date, or initial the document). The recipient information may include contact information for a recipient (e.g., a name and email address).

Interface module 226 may execute an interface by which other systems or devices may determine operations of identity verification manager 112 or name matching manager 114. Another system or device may communicate via an interface of interface module 226 to specify one or more name matching rules 118.

The interface module 226 may execute and present an API. The interface presented by interface module 240 may be a gRPC, HTTP, RESTful, command-line, graphical user, web, or other interface.

FIG. 3 is a block diagram illustrating training of a machine learning model, in accordance with techniques of this disclosure. In an aspect, the name matching manager 114 may employ a probabilistic multiclass classifier as a machine learning model to perform a name matching prediction. In FIG. 3, an exemplary name classification system (machine learning model) 300 is illustrated in a training environment. The classification system 300 takes as input a large collection of labeled (classified) samples (shown as training data 220 in FIG. 2). The system 300 is trained using a labeled set of name pairs 302. In an aspect, the name pairs may then be processed to extract one or more derivative feature sets, such as Metaphone codes, SoundEx codes and Levenshtein distance scores described in greater detail below. In an aspect, these features are provided for each name pair 302 as part of the training data 220.

In an example, the metaphone codes may be calculated using a Metaphone algorithm. The metaphone algorithm typically produces a longer token than Soundex and therefore tends to group names together that are more closely related than Soundex does. Metaphone also tends to produce more matches than Soundex. The metaphone algorithm generates a key value or token for a word based on the significant vowel and consonant audible signatures in that word. Metaphone uses more intelligent transformation rules, as compared to Soundex, by examining groups of letters, or diphthongs.

As one non-limiting example, the metaphone algorithm can be as follows:
1. All non-alphabetic characters are removed from the word.
2. The word is converted to uppercase.
3. All vowels are removed from the word, unless the word begins with a vowel.
4. Consonants are then mapped to their metaphone code.
5. If any consonants except “c” are repeated, the second consonant is removed.

Metaphone encodes sixteen consonant sounds: BXSKJTFHLMNPROWY.

Please note that X represents the “sh” sound, and O represents the “th” sound.

These following transformations are made at the beginning of a word:
“AE-”, “GN”, “KN-”, “PN-”, “WR-” drop first letter
“X” change to “s”
“WH-” change to “w”

Unless otherwise noted, the following initial vowels are transformed as follows:
A changes to 9
E changes to 9
I changes to 9
O changes to 8
U changes to 8
Y changes to 7

The following Table 1 illustrates example transformation rules are used by metaphone after the beginning of the word has been processed. The first column in Table 1 is the letter to be transformed, the second column is the letter to which it is transformed for the condition given in the description for that transformation (column 3). Where there is more than one transformation for a particular letter, the most suitable transformation is that which most closely represents the use of the letter according to the description.

TABLE 1

| | Letter to which it | |
|---|---|---|
| | is transformed for | |
| Letter to be | the condition given | |
| transformed | in the description | Transformation Description |
| B | B | unless at the end of word |
| | | after “m”, as in “bomb” |
| C | X | (sh) if “-cia-” or “-ch-” |
| C | S | if “-ci-”, “-ce-”, or “-cy-” |
| | | SILENT if “-sci”, “-sce-”, |
| | | or “-scy-” |
| C | K | otherwise, including in |
| | | “-sch-” |
| D | J | if in “-dge-”, “-dgy-”, |
| | | or “-dgi-” |
| D | T | otherwise |
| F | F | |
| G | SILENT | if in “-gh-” and not at end |
| | | or before a vowel in “-gn” |
| | | or “-gned” |
| | | in “-dge-” etc., as in above |
| | | rule |
| G | J | if before “i”, or “e”, or |
| | | “y” if not double “gg |
| G | K | otherwise |
| H | SILENT | if after vowel and no vowel |
| | | follows |
| | | or after “-ch-”, “-sh-”, |
| | | “-ph-”, “-th-”, “-gh-” |
| H | H | otherwise |
| J | J | |
| K | SILENT | if after “c” |
| K | K | otherwise |
| L | L | |
| M | M | |
| N | N | |
| P | F | if before “h” |
| P | P | otherwise |
| Q | K | |
| R | R | |
| S | X | (sh) if before “h” or in |
| | | “-sio-” or “-sia-” |
| S | S | otherwise |
| T | X | (sh) if “-tia-” or “-tio-” |
| T | O | (th) if before “h” silent |
| | | if in “-tch-” |
| T | T | otherwise |
| V | F | |
| W | SILENT | if not followed by a vowel |
| W | W | if followed by a vowel |
| X | KS | |
| Y | SILENT | if not followed by a vowel |
| Y | Y | if followed by a vowel |
| Z | S | |

The Soundex algorithm may be adapted to compare a phonetic similarity between English words (e.g . . . . Cyndie vs. Cindy) in such a manner that it removes vowels from the English pronunciation of words, assigns the same code to every group of analogously pronounced consonants among the remaining consonants and determines that the words are similar in pronunciation if their Soundex code strings are the same.

An example process for producing a Soundex code string is as follows:
(1) removes all vowels from each word;
(2) removes ‘H’, ‘W’ and ‘Y’ and all successively repeated same ones from consonants; and
(3) substitutes the next three letters except the initial one with Soundex codes as shown in the Table 2 below:

TABLE 2

| CONSONANTS | CODES |
|---|---|
| B F P V | 1 |
| C G J K Q S X Z | 2 |
| D T | 3 |
| L | 4 |
| M N | 5 |
| R | 6 |

An example process of determining a similarity between two strings (names) that is used by the aforementioned machine learning model 300 comprises the Levenshtein distance (LEV) heuristic. The Levenshtein heuristic produces a matrix of hamming distances, which provides a measure of the similarity of the two strings.

In an example, the Levenshtein distance may be determined by calculating a Levenshtein matrix. If the first string (S1) has a length of m and the second string (S2) has a length of n, the elements of the Levenshtein matrix D can be calculated in accordance with Equation (1), as follows:

$$D [ i , j ] = minimum of ( D [ i - 1 , j ] + 1 , D [ i , j - 1 ] + 1 , or D [ i - 1 , j - 1 ] + cost ) \qquad ( 1 )$$

Where i=1 to n, j=1 to m, element [0,j]=j, element [i,0]=i, and element [0,0]=0. In one implementation, the cost is 0 if S1 [i]=S2 [j], and 1 if S1 [i]/S2 [j]. The Levenshtein distance is specified by element D [m,n] As a heuristic, the greater the Levenshtein distance, D [m,n], the greater the difference is between the two strings.

In an example, the training data 220 may include the Levenshtein distance scores calculated for: 1) the distance between two names (name pairs 302); 2) the distance between two corresponding Metaphone codes and 3) the distance between two corresponding SoundEx codes.

In other words, each entry in the training data 220 may include information shown in the Table 3 below:

TABLE 3

| | | Metaphone | Metaphone | SoundEx | SoundEx | Lev | Lev | Lev | |
|---|---|---|---|---|---|---|---|---|---|
| Name 1 | Name 2 | Code 1 | Code 2 | Code 1 | Code 2 | Distance 1 | Distance 2 | Distance 3 | Match? |
| Henry | Henry J. | NRY RN | NRY J RN | H566 | H562 | 0.79 | 0.83 | 0.75 | True |
| Aaron | Aaron | | | | | | | | |

An example of the training data 220 may include hundreds of thousands of samples presented as data shown in the Table 3. In the example of FIG. 3, document management platform 102 may perform the machine learning model training 308 based on input strings (name pairs 302), features indicative of similarity between two strings (304), and the assigned label 306. In this example, document management platform 102 may perform the machine learning model training 308 using Soundex, Metaphone, and Levenshtein distances as extracted features, however, document management platform 102 may additionally or alternatively extract other features indicative of similarity between two strings. Machine learning model training 308 may include training the machine learning model to determine the number of acceptable minor spelling errors, for example, by employing a statistical metric that considers the number of letters in the original names.

For example, document management platform 102 may “learn” from training data 220. In this example, document management platform 102 may identify, with the right input (e.g., name pair combinations) patterns and make a prediction. For example, training data 220 may include: 1) a textual input as: full name 1 and full name 2; and 2) a binary label of True (match)/False (not match). Document management platform 102 may perform the machine learning model training 308 using Soundex, Metaphone, and Levenshtein distances as extracted features of the names and/or using other features of the names. In this way, document management platform 102 may perform a name matching operation using machine learning model 308 (e.g., Model.zip) as shown in Table 4 below:

TABLE 4

| Full name 1 | Full name 2 | |
|---|---|---|
| (Envelope) | (Government ID) | Match |
| Aaron Smith | Aaron Smith | True |
| Aaron Smith | Robert Smith | False |

Document management platform 102, and more specifically, name matching manager 114, may perform a name matching operation using the machine learning model generated during machine learning model training 308 (e.g., Model.zip). For example, document management platform 102 may use the machine learning model training 308 (e.g., Model.zip) for a single prediction where the sample data includes and/or consists of two names, 5 parameters, and a “NO” label. The label is what the model should predict from the data. Document management platform 102 may make predictions based on the probabilistic value obtained in the output. For example, with the threshold is set to 50% by default, anything above 50 will be assigned to the True class (e.g., the first name and the second name are similar) and everything else to the fails class (e.g., the first name and the second name are not similar). The threshold value may be editable. For example, if the pair “Name1”, “Name 2” gives [0.56; 0.44] points. Then the pair is assigned to the class “True” with a probability of 0.56. If the pair “Name1”. “Name 2” gives [0,38; 0.62] points. Then the pair is classified as “False” with a probability of 0.62.

FIG. 4 is a block diagram illustrating prediction performed by a machine learning model, in accordance with techniques of this disclosure. In FIG. 4, an exemplary machine learning model 300 is illustrated in an operating environment. As shown in FIG. 4, the machine learning model 300 may take as input a name pair 402 to be classified. In an aspect, the machine learning model 300 may assign a class label 410 probabilistically to the input name pair 402, based on labels of samples stored in the training data 220 which may contain a large collection of labeled (classified) samples. The exemplary sample is shown in the Table 3 above. In an aspect, the machine learning model 300 may be configured to process each name pair 402 to extract one or more derivative feature sets, such as Metaphone codes, SoundEX codes and Levenshtein distance scores described above.

In an example, the machine learning model 300 may generate a probabilistic similarity score based on the input name pair 402, the extracted feature set 404 and the training data 402. For example, the generated similarity scores may be calculated by the machine learning model 300 as probability of association between the input name pair 402.

In an example, the machine learning model 300 may compare the generated similarity score with a predefined threshold and assign the label 410 based on the comparison. For example, the predefined threshold may be set to 50%. In other words, the similarity score above 50% will be assigned to the class “True” (Match) and all other similarity scores will be assigned to the “False” (No match) class by the machine learning model 300. As non-limiting example, if the machine learning model 300 generates the similarity score of 0.56 for the first input name pair 402, the machine learning model 300 may assign the first input name pair 402 to the “True” class and may assign the True class label 410 to the first input name pair 402 as the result. However, if the machine learning model 300 generates the similarity score of 0.38 for the second input name pair 402, the machine learning model 300 may assign the second input name pair 402 to the “False” class and may assign the false class label 410 to the second input name pair 402 as the result.

In various aspects, the machine learning model 300 may be implemented as any classifier or detector, such as a model-based classifier or a learned classifier (e.g., classifier based on machine learning). For learned classifiers, binary or multi-class classifiers may be used, such as Bayesian, boosting or neural network classifiers. In one aspect, the machine learning model 300 may be a machine-trained probabilistic boosting tree. Such classifier may be constructed as a tree structure. The machine-trained probabilistic boosting tree may be trained from a training data set (training data 220).

FIG. 5 is a flow chart illustrating an example mode of operation for a documentation platform to perform comparison of names, in accordance with techniques of this disclosure. Mode of operation 500 is described with respect to the document management platform 102 and FIGS. 2-4.

The document management platform 102 may allow a sender to create and send documents to one or more recipients for negotiation, collaborative editing, electronic execution (e.g., electronic signature), automation of contract fulfilment, archival, and analysis, among other tasks. In one non-limiting example, a user of the mobile device 108B may be a sender of a document package and a user of the client device 109A may be a recipient of the document package. In some aspects, in advance of the execution of the documents, the sender may generate a document package to provide to the one or more recipients. The document package may include at least one document to be executed by one or more recipients. In some aspects, the document package may also include one or more permissions defining actions the one or more recipients can perform in association with the document package. The document package may also include recipient information and document fields indicating which fields of the document need to be completed for execution (e.g., where the recipient should sign, date, or initial the document). The recipient information may include contact information for a recipient (e.g., a name and email address). The recipient's name provided by the sender is referred to hereinafter as first name. At 501, the document management platform 102 may transmit the document package to the recipient.

At 502, the identity verification manager 112 may verify identity of the recipient based on recipient's identity document, such as but not limited to a driver's license, a passport, or other form of government issued identification. In this case, the identity verification manager 112 may obtain an image (e.g., a front and/or a back) of the identity document to provide to the document management platform 102, such as by using a camera component of the recipient device 108A, 109A to capture the image. In various aspects, the identity verification manager 112 may process the image of the identity document to extract identity (e.g. name) of the recipient. The identity verification manager 112 may be part of the document management platform 102 or may be separate (e.g., a third-party system). The identity verification manager 112 may process the image of the identity document and/or data from an electronic identity document to extract the identity of the recipient from the identity document using, for example, one or more of text, image data (e.g., pictures or barcodes), or security features. While the foregoing examples use an identity document to determine the identity of the recipient, some examples may determine the identity of the recipient using other techniques to identity the recipient. The recipient name extracted from the identity document or verified by other means is referred to hereinafter as second name.

At 503, the name matching manager 114 may employ a probabilistic multiclass classifier as a machine learning model to perform a name matching prediction. In an aspect, the machine learning model of the name matching manager 114 may assign a class label 410 probabilistically to the input name pair 402 (e.g., first name and second name), based on labels of samples stored in the training data 220 which may contain a large collection of labeled (classified) samples. The exemplary sample is shown in the Table 3 above. In an aspect, the name matching manager 114 may be configured to process each name pair 402 to extract one or more derivative feature sets, such as Metaphone codes, SoundEX codes and Levenshtein distance scores described above.

At 504, the name matching manager 114 may analyze classification results to determine whether the first name and the second name are similar based on a similarity score generated by the machine learning model. In an aspect, the name matching manager 114 may determine that the first name and the second name are similar if the similarity score exceeds a predefined threshold. Based on determining that the first name and the second name are similar (504, Yes branch), the document management platform 102 may grant the recipient access to the transmitted document package (509). For example, document management platform 102 may grant the recipient access to the transmitted document package in response to validating the identity of the recipient and by determining that one or more security criteria are satisfied.

In response to determining that the first name and the second name are not similar (504, No branch), the document management platform 102 may apply one or more name matching rules describing constraints for determining whether the second name is an allowed alternative representation of the first name (506). The name matching rules may include rules relating to different types of name features, such as letter cases, diacritical conversions, transliterations, name types (e.g., first, middle, last), special characters (e.g., initials), suffixes, elimination of middle names from the original name to enhance the matching process, and the like. The examples of rules described below are provided for the purpose of illustration only, and other types of name matching rules may be used to compare corresponding names.

The name matching rules may include case sensitivity name matching rules. The case sensitivity name matching rules may describe constraints relating to how letter case should or should not be considered for determining if identity source and recipient name data match. The case sensitivity name matching rules may include various specific rules that result in identity document name data matching or not matching recipient name data.

As another example, the diacritics name matching rules may describe constraints relating to how diacritics should or should not be considered for determining if identity source and recipient name data match. The diacritics name matching rules may include various specific rules that result in names matching or not matching each other based on diacritics name features. For instance, according to the “ignore diacritics” rule both “Č” and “\grave{C}” are equivalent to “C.”

In a non-limiting example, the transliteration name matching rules may describe constraints relating to how letters or symbols can be matched with equivalent transliterations for determining if two names match. The transliteration name matching rules may include various specific rules that result in identity document name data matching or not matching recipient name data. In some aspects, the document management platform 102 applying the transliteration name matching rules may use a dictionary mapping a letter or symbol to one or more equivalent transliterations corresponding to the letter or symbol, or vice versa. In this case, the dictionary may be configured by the document management platform 102 or may be provided by a third-party service. In the same or different aspects, the transliteration name matching rules may be configured to accept some transliterations as equivalent and not others.

In an example, the name matching rules may also include name type name matching rules. The name type name matching rules may describe constraints relating to how a number or type of matching names can be considered for determining if identity source and recipient name data match (e.g., a number of first names, last names, middle names, etc.). The name type name matching rules may include various specific rules that result in names matching or not matching based on name type name features. As an example, the name type name matching rules may include one or more rules that require at least one matching first name, at least one matching last name, or both. In other cases, the name type name matching rules may include additional or alternative rules.

In response to determining that the second name is an allowed alternative representation of the first name (507, Yes branch), the document management platform 102 may grant the recipient access to the transmitted document package (509). In an aspect, in response to determining that the second name is not an allowed alternative representation of the first name (507, No branch), the document management platform 102 may deny the recipient access to the transmitted document package (508).

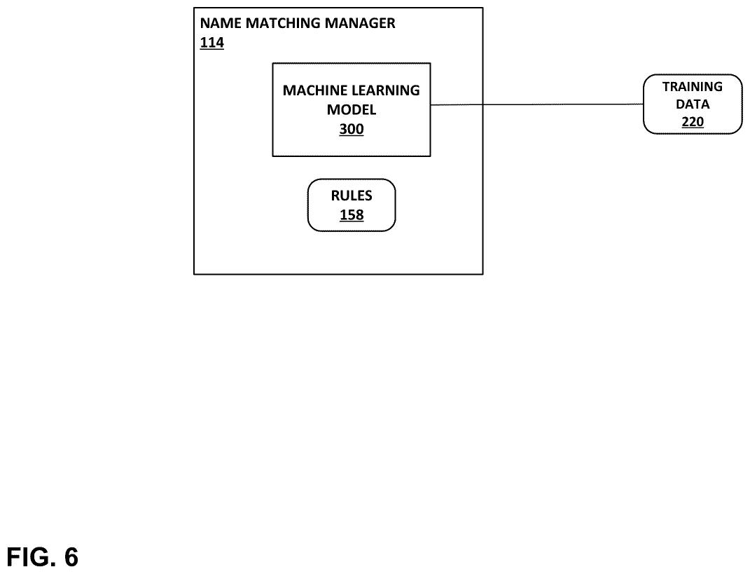

FIG. 6 is a block diagram illustrating an example of the name matching manager 114 in further detail. In FIG. 6, the name matching manager 114 includes machine learning (ML) model 300 trained to perform a name matching prediction.

A machine learning system separate from the document management platform 102 may be used to train ML model 300. The machine learning system may be executed by a computing system having hardware components similar to those described with respect to computing system 202. The ML model 300 may include one or more neural networks, such as one or more of a Deep Neural Network (DNN) model, Recurrent Neural Network (RNN) model, and/or a Long Short-Term Memory (LSTM) model. In general, DNNs and RNNs learn from data available as feature vectors, and LSTMs learn from sequential data.

The machine learning system may apply other types of machine learning to train the ML model 300. For example, the machine learning system may apply one or more of nearest neighbor, naïve Bayes, decision trees, linear regression, support vector machines, neural networks, k-Means clustering, Q-learning, temporal difference, deep adversarial networks, or other supervised, unsupervised, semi-supervised, or reinforcement learning algorithms to train the ML model 300.

The ML model 300 processes training data for training ML model 300, data for prediction, or other data. The training data 220 which may contain a large collection of labeled (classified) samples. The exemplary sample is shown in the Table 3 above. The ML model 300 may in this way be trained to identify name matching patterns.

For processes, apparatuses, and other examples or illustrations described herein, including in any flowcharts or flow diagrams, certain operations, acts, steps, or events included in any of the techniques described herein can be performed in a different sequence, may be added, merged, or left out altogether (e.g., not all described acts or events are necessary for the practice of the techniques). Moreover, in certain examples, operations, acts, steps, or events may be performed concurrently, e.g., through multi-threaded processing, interrupt processing, or multiple processors, rather than sequentially. Further certain operations, acts, steps, or events may be performed automatically even if not specifically identified as being performed automatically. Also, certain operations, acts, steps, or events described as being performed automatically may be alternatively not performed automatically, but rather, such operations, acts, steps, or events may be, in some examples, performed in response to input or another event.

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

In accordance with one or more aspects of this disclosure, the term “or” may be interrupted as “and/or” where context does not dictate otherwise. Additionally, while phrases such as “one or more” or “at least one” or the like may have been used in some instances but not others; those instances where such language was not used may be interpreted to have such a meaning implied where context does not dictate otherwise.

In one or more examples, the functions described may be implemented in hardware, software, firmware, or any combination thereof. If implemented in software, the functions may be stored, as one or more instructions or code, on and/or transmitted over a computer-readable medium and executed by a hardware-based processing unit. Computer-readable media may include computer-readable storage media, which corresponds to a tangible medium such as data storage media, or communication media including any medium that facilitates transfer of a computer program from one place to another (e.g., pursuant to a communication protocol). In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can include RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the terms “processor” or “processing circuitry” as used herein may each refer to any of the foregoing structure or any other structure suitable for implementation of the techniques described. In addition, in some examples, the functionality described may be provided within dedicated hardware and/or software modules. Also, the techniques could be fully implemented in one or more circuits or logic elements.

The techniques of this disclosure may be implemented in a wide variety of devices or apparatuses, including a wireless handset, a mobile or non-mobile computing device, a wearable or non-wearable computing device, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperating hardware units, including one or more processors as described above, in conjunction with suitable software and/or firmware.

1. A method for enabling interaction with a document, the method comprising:
transmitting, by a document management platform implemented by a computing system, a document package to a second computing device, wherein the document package includes an electronic document received from a first computing device and an indication of first name;
obtaining, by the document management platform, an indication of a second name from an identity document provided by a user of the second computing device;
performing, by the document management platform, a name matching operation using a machine learning model to determine whether the first name and the second name are similar based on a similarity score generated by the machine learning model;
in response to the machine learning model determining that the first name and the second name are not similar, applying, by the document management platform, one or more name matching rules describing constraints for determining whether the second name is an allowed alternative representation of the first name; and
in response to determining that the second name is the allowed alternative representation of the first name or in response to the machine learning model determining that the first name and the second name are similar, granting, by the document management platform, the user of the second computing device access to the electronic document.

2. The method of claim 1, further comprising:
comparing the generated similarity score with a predefined threshold;
in response to determining that the generated similarity score is equal to or greater than the predefined threshold, determining, by the document management platform, that the first name and the second name are similar; and
in response to determining that the generated similarity score is less than the predefined threshold, determining by the document management platform, that the first name and the second name are not similar.

3. The method of claim 1, wherein the machine learning model comprises a trained probabilistic multiclass classifier.

4. The method of claim 3, wherein the machine learning model is trained using a database of name pairs.

5. The method of claim 4, wherein the database of name pairs includes, for each named pair, an indication of whether the name pair matches and one or more of one or more phonetic indexing metrics; or one or more similarity distance metrics.

6. The method of claim 1, wherein the document management platform is configured to extract a plurality of features from the first name and the second name.

7. The method of claim 6, wherein the plurality of extracted features includes at least one of:
one or more phonetic indexing metrics; or
one or more similarity distance metrics.

8. The method of claim 7, wherein the one or more phonetic indexing metrics is based on English pronunciation.

9. The method of claim 7, wherein the one or more phonetic indexing metrics include at least one of a metaphone code or a SoundEx code.

10. The method of claim 7, wherein the one or more similarity distance metrics are determined based on: one or more of:
similarity distance between the first name and the second name;
similarity distance between a first metaphone code corresponding to the first name and a second metaphone code corresponding to the second name; or
similarity distance between a first SoundEx code corresponding to the first name and a second SoundEx code corresponding to the second name.

11. (canceled)

12. The method of claim 1, wherein the one or more name matching rules include at least one or more of a case sensitivity matching rule, a diactrics name matching rule, a transliteration name matching rule, a name type name matching rule, a special character name matching rule, or an initial name matching rule.

13. The method of claim 1, wherein the second name string is extracted from an image of the identity document captured by the second computing device.

14. The method of claim 1, wherein the second name string is extracted from an electronic identity document.

15. The method of claim 1, wherein the machine learning model comprises a trained neural network.

16. The method of claim 1, wherein the document package includes an email address.

17. The method of claim 1, wherein the first name comprises one or more of a given name, a middle name, and a family name.

18. A computing system comprising:
a storage device; and
processing circuitry having access to the storage device and configured to:
transmit a document package to a second computing device, wherein the document package includes an electronic document received from a first computing device and an indication of first name;
obtain an indication of a second name from an identity document provided by a user of the second computing device;
perform a name matching operation using a machine learning model to determine whether the first name and the second name are similar based on a similarity score generated by the machine learning model;
in response to the machine learning model determining that the first name and the second name are not similar, apply one or more name matching rules describing constraints for determining whether the second name is an allowed alternative representation of the first name; and
in response to a determination that the second name is the allowed alternative representation of the first name or in response to the machine learning model determining that the first name and the second name are similar, grant, by the document management platform, the user of the second computing device access to the electronic document.

19. The computing system of claim 18, wherein the processing circuitry is further configured to:
compare the generated similarity score with a predefined threshold;
in response to determining that the generated similarity score is equal to or greater than the predefined threshold, determine that the first name and the second name are similar, and
in response to determining that the generated similarity score is less than the predefined threshold, determine that the first name and the second name are not similar.

20. Non-transitory computer-readable storage media comprising instructions that, when executed, configure processing circuitry of a computing system to:
transmit a document package to a second computing device, wherein the document package includes an electronic document received from a first computing device and an indication of first name;
obtain an indication of a second name from an identity document provided by a user of the second computing device;
perform a name matching operation using a machine learning model to determine whether the first name and the second name are similar based on a similarity score generated by the machine learning model;
in response to the machine learning model determining that the first name and the second name are not similar, apply one or more name matching rules describing constraints for determining whether the second name is an allowed alternative representation of the first name; and
in response to a determination that the second name is the allowed alternative representation of the first name or in response to the machine learning model determining that the first name and the second name are similar, grant the user of the second computing device access to the electronic document.
